(19) United States
(12) Patent Application Publication
(10) Pub. No.: US 2018/0282672 A1
(43) Pub. Date: Oct. 4, 2018

(54) DETERGENT PRODUCT

(71) Applicant: Henkel AG & Co. KGaA, Duesseldorf (DE)

(72) Inventors: Frank Meier, Duesseldorf (DE); Katja Gerhards, Duesseldorf (DE); Matthias Sunder, Duesseldorf (DE)

(73) Assignee: Henkel AG & Co. KGaA, Duesseldorf (DE)

(21) Appl. No.: 15/935,589

(22) Filed: Mar. 26, 2018

(30) Foreign Application Priority Data
Mar. 31, 2017 (DE) 102017205549.9

(51) Int. Cl. C11D 17/04

(52) U.S. Cl. CPC C11D 17/045

(57) ABSTRACT

A detergent product for treating textiles is described, including a film pouch having a plurality of pouch chambers which are each enclosed by at least one water-soluble film, wherein the pouch chambers are formed by water-soluble films connected to one another in a sealing plane and are separated from one another by sealing sections located in the sealing plane, and wherein the pouch chambers are each filled with a detergent preparation. To achieve a compact arrangement of the pouch chambers with narrow sealing sections between the pouch chambers in the sealing plane, a high intrinsic stability and a better dissolution behavior of the detergent product, a plurality of pouch chambers are provided in the detergent product in a number n≥3, wherein the pouch chambers are arranged in at least one sectional plane around a common n-fold axis of rotation that is perpendicular to the sectional plane.

### FIELD OF THE INVENTION

The invention relates to a detergent product, in particular for treating textiles, more particularly for cleaning textiles and/or washing textiles, comprising a film pouch having a plurality of pouch chambers which are each enclosed by a water-soluble film, wherein the pouch chambers are formed by water-soluble films connected to one another in a sealing plane and are separated from one another by sealing sections located in the sealing plane, and wherein the pouch chambers are each filled with a detergent preparation.

### BACKGROUND OF THE INVENTION

Water-soluble detergent products in the form of a single-use portion pack for treating textiles are known. Such a portion pack is used only once for treating textiles, usually in a textile washing machine. The detergent product comprises a film pouch having one or more pouch chambers. Accommodated in each pouch chamber is a detergent preparation which contains active washing substances for treating textiles, in particular for washing textiles. The use of multiple pouch chambers opens up the possibility of separately holding different detergent preparations which under some circumstances chemically react with one another or are not storage-stable for other reasons when mixed together. In addition, the use of multiple different detergent preparations within one wash cycle permits the release of multiple, functionally different washing substances and/or additive substances, such as for example bleaches, fabric softeners or fragrances. If multiple pouch chambers are provided, the individual detergent preparations within the pouch chambers may have an identical or different consistency and are preferably of liquid consistency, for example liquid, gel-like, pasty or wax-like, or of solid consistency, for example in powder, granule, free-flowing or solid form. In the context of the invention, the term “detergent preparation” is to be understood in the broad sense.

Once the detergent products in question have been added to water, the film dissolves and releases the detergent preparation. The film pouch may be formed of a plurality of water-soluble films, the water-soluble film preferably being PVA film (polyvinyl alcohol film). The films that can be used usually consist of polyvinyl alcohol copolymers with suitable additives such as plasticizers, water, surfactants, antioxidants, slip agents, release agents, bittering agents or salts. The film pouch may be manufactured from a water-soluble base film and a water-soluble cover film, which form the boundary walls of at least one pouch chamber. The base film may for example be deep-drawn in a plastically deforming manner in order to form at least one pouch chamber. The base film and the cover film are then sealed to one another or connected to one another in one or more sealing or connecting sections. The sealing sections are then located in a so-called sealing plane or connecting plane of the two films.

Detergent products having multiple pouch chambers are known for example from DE 10 2014 102 567 A1. The detergent product described in the aforementioned document may comprise a plurality of chambers which may be arranged in a manner aligned above each other, that is to say positioned one above the other. Arrangements in which the chambers are arranged alongside one another, that is to say positioned one next to the other, are also possible. Chambers may also be arranged in such a way that a first chamber is located next to a second chamber, but the first chamber at least partially surrounds the second chamber but does not completely enclose the second chamber. Alternatively, one chamber may also be completely enclosed by another chamber. The chambers may be of different sizes and may each contain a laundry washing, textile care or dishwashing composition, including pretreatment or soaking compositions and other washing compositions. The composition may also be a detergent composition or a machine dishwashing composition. The detergent composition may be used during the main wash cycle or it may be used as a pretreatment or soaking composition.

A detergent product comprising a water-soluble pouch which has a plurality of pouch chambers arranged next to one another is known for example from EP 2 617 659 B1. Two separate chambers are each filled with a cleaning agent, wherein the film pouch is manufactured from a water-soluble base film and a water-soluble cover film which are sealingly connected to one another in a sealing plane. The pouch chambers are separated from one another by sealing sections located in the sealing plane. The base film is deep-drawn in a plastically deforming manner in order to form the pouch chambers. In the sealing plane, a first pouch chamber has a first footprint and a second pouch chamber has a second footprint. The film pouch has a third footprint, wherein the first footprint of the first pouch chamber has a concave section on its side facing toward the second pouch chamber, and wherein the second footprint of the second pouch chamber has a convex section on its side facing toward the first pouch chamber. The convex section of the second pouch chamber extends into the concave section of the first pouch chamber. The second footprint of the second pouch chamber has at least one concave section to the side of its convex section, said concave section being adjacent to at least one convex section of the first footprint. This geometry is intended to achieve a certain intrinsic shape stability of the film pouch, so that the pouch chambers do not fold and bend relative to one another when the film pouch is manually held. This is because folding or bending of the pouch chambers will often be interpreted by users of the detergent products in question to be an indication of supposedly poor product quality.

Detergent products which have pouch chambers of geometrically simple design arranged next to one another usually have an insufficient intrinsic shape stability of the film pouch, with the result that such product designs are considered by users to be of inferior quality. In addition, a low shape stiffness of the detergent product is associated with unsatisfactory processability during manufacture and further processing of the products.

From the user's point of view, a large footprint of the film pouch and wide sealing sections between the pouch chambers may make it questionable whether the detergent product will (completely) dissolve during a wash cycle. In fact, the dissolution behavior of multi-chamber capsules, that is to say the rate of dissolution and the degree of dissolution during a wash cycle, often does not meet the high expectations of consumers of water-soluble detergent products. The pouch chambers of known multi-chamber capsules form attachment surfaces for parts of laundry items, such as buttons or appliqués, which leads to the detergent product becoming caught in the laundry and then being transported along with an item of laundry and riding on the load of laundry. This can lead to an uneven and poor flow around the detergent product during a wash cycle and thus to a delayed and insufficient dissolution of the film material, in particular of the sealing seams in the middle region of the film pouch. It may sometimes be observed that the pouches ride on the load of laundry and are conveyed underneath the porthole door, that is to say the loading opening in washing machines of the front loader type, onto the rubber sleeve which is quite wide at that point. Depending on the manufacturer and type of machine, the pouches are from then on exposed only to very little contact with water or no contact with water at all, which almost inevitably leads to pouch residues. In addition, it is also more difficult for the pouch to dissolve on the rubber sleeve due to the lack of mechanical impact. This effect is extremely undesirable and is in contrast to the desired situation, according to which the pouch is exposed to mechanical impact during the wash cycle when it comes into contact with the laundry drum and the load of laundry. The geometry and shape of the pouch chambers also contribute to a non-optimal dissolution behavior of the known detergent products, wherein, between adjacent pouch chambers, regions form which are exposed to a poorer flow and which are not sufficiently dissolved at the end of a wash cycle.

It is true that the product design of water-soluble multi-chamber capsules permits designs which from the user's point of view are perceived as esthetically more pleasing than single-chamber capsules and as a sign of an innovative product concept. However, the film consumption for producing multi-chamber capsules is around 10 to 50% greater than the film consumption for producing single-chamber systems with the same total amount of detergent preparation contained in the pouch chamber or pouch chambers. The higher film consumption can be attributed to the use of a third film layer for producing the chambers in the case of detergent products having a plurality of chambers arranged one above the other, and to a non-optimized shaping of adjacent pouch chambers with wide sealing sections between the chambers in the case of detergent products having pouch chambers arranged next to one another. The higher film consumption leads to higher production costs. Moreover, a high film consumption is in conflict with an ever-increasing environmental awareness of users and the desire for resource-saving production processes.

### BRIEF SUMMARY OF THE INVENTION

Proceeding from the prior art described above, the problem addressed by the invention is that of providing a generic detergent product which has a high intrinsic shape stability and enables improved use particularly in textile washing machines, which also includes in particular an improved dissolution behavior during the washing process. The detergent product according to the invention should be characterized in particular by a high rate of dissolution and a largely residue-free dissolution during a predefined wash cycle in a textile washing machine. In addition, the detergent product should be easy to manufacture in an inexpensive and resource-saving manner while exhibiting good processability and should satisfy the high demands of users for an innovative product design.

In order to solve the aforementioned problem, it is proposed in a detergent product of the type mentioned in the introduction that a plurality of pouch chambers are provided in a number n≥3, wherein the pouch chambers are arranged in at least one sectional plane around a common n-fold axis of rotation that is perpendicular to the sectional plane. By rotating the film pouch or detergent product about the axis of rotation through an angle of 360°/n, the arrangement of the pouch chambers can be brought back into line with themselves, in relation to the areas of the pouch chambers in the sectional plane. If the film pouch or detergent product rotates about the axis of rotation and if the arrangement of the pouch chambers upon rotation through 360°/n remains substantially indistinguishable from the starting state, then the film pouch has an n-fold axis of rotation in the context of the present invention. In the case of a three-fold axis of rotation, for example, a rotation of the film pouch through an angle of in each case 120° about the axis of rotation leads to the situation whereby the sectional areas of the pouch chambers in the sectional plane are in each case brought back into line with themselves. This results in a total of three symmetry equivalents or substantially congruent arrangements of the pouch chambers, in relation to the sectional areas of the pouch chambers in the sectional plane.

In the context of the invention, the term “detergent product” is to be understood in the broad sense and also includes in particular those products which are used for cleaning dishes in dishwashers. The term “detergent preparation” is thus likewise to be understood in the broad sense and also includes for example machine dishwashing detergents and rinse aids. The following observations relating to the use of the detergent product according to the invention in textile washing machines also apply accordingly to embodiments of the detergent product according to the invention for use in dishwashers, without this being discussed in detail.

The inventive rotationally symmetrical design of the film pouch having at least three pouch chambers leads to a product design which is characterized by a high intrinsic stability. The folding or bending of the pouch chambers relative to one another during production, processing and use can be considerably reduced, so that the processability is improved and the detergent product according to the invention is perceived by users as being of particularly high quality.

In addition, by virtue of the inventive arrangement of the pouch chambers around a common n-fold axis of rotation, an esthetically pleasing product design can be achieved, which contributes to a high level of user acceptance.

The pouch chambers can be configured in a flow-optimized manner and arranged relative to one another in a flow-optimized manner which, when used in a textile washing machine, leads to an even and intensive flow around and over the pouch chambers in combination with a fast and largely complete dissolution of the film material. The film chambers can in particular be configured in such a way that fewer attachment surfaces are created for laundry parts, such as buttons and/or appliqués. The detergent products according to the invention therefore do not become so easily caught on laundry parts and are thus moved more intensively during a wash cycle, thereby ensuring sufficient contact with water during the wash cycle.

Finally, embodiments of the pouch chambers and of the arrangement thereof relative to one another are possible which are characterized by a very compact structure. The compact structure leads to reduced material consumption. Production and packaging processes are simplified.

The product design, that is to say the geometric shape of the pouch chambers, the size thereof and the arrangement thereof relative to one another, may additionally provide very narrow sealing sections between adjacent chambers, which leads to a reduction in the dimensions of the detergent product according to the invention and thus enables maximum use of the capacities of the apparatus and machines used for producing and transporting the detergent products. The external appearance of the detergent products is also enhanced.

The pouch chamber may be formed by at least two, preferably only two, film layers which are sealed to one another in one or more sealing sections. Preferably, only pouch chambers which are arranged next to one another and which are separated from one another are provided, and no superposed/overlapping pouch chambers are provided, so that it is possible to produce the film pouch using only two film layers. This leads to reduced production costs and to a reduced production complexity. The film pouch may be manufactured from a water-soluble base film and a water-soluble cover film, which are sealingly connected to one another in the sealing plane. The base film may be deep-drawn in a plastically deforming manner in order to form pouch chambers.

The pouch chambers are separated from one another by sealing sections located in the sealing plane. The sealing sections may in particular be formed to run in a non-rectilinear manner and thus ensure a desired high intrinsic shape stability of the detergent product.

The outer contour of the film pouch in the sealing plane may preferably be circular, triangular or quadrangular. Shaping may take place for example by laser cutting or punching. Other outer contours of the film pouch are not ruled out.

In one particularly preferred embodiment, the pouch chambers have identical footprints in the sealing plane, which are arranged around a common n-fold axis of rotation that is perpendicular to the sealing plane, where n is the number of pouch chambers. When producing the pouch chambers by plastic deformation of a base film in a deep-drawing die and subsequent bonding to a cover film, the shape and size of the footprints are predefined by the contour of the chamber cavities of the deep-drawing die. In the context of the invention, “identical” encompasses an exactly identical shape and size of the footprints or also an approximately identical shape and size of the footprints, that is to say a largely corresponding shape and size, so that, during an n-fold rotation of the film pouch about the axis of rotation, substantially symmetry-equivalent appearances of the footprints in the sealing plane are obtained. In the context of the invention, “substantially symmetry-equivalent appearances of the footprints” exist in particular when the degree of congruence of the footprints of the pouch chambers after rotating the film pouch through 360°/n from a 0° position in the starting state, that is to say for example a rotation of the film pouch through 120° in the case of a three-fold axis of rotation, is at least 90%, preferably at least 95%, in each case in relation to the starting state.

The film pouch may have between three and ten pouch chambers, preferably between three and five pouch chambers, which may contain identical or different detergent preparations. The pouch chambers may therefore be arranged around a three-fold to nine-fold axis of rotation, preferably around a three-fold or four-fold or five-fold axis of rotation. Despite the high number of chambers, a compact and flow-optimized structure having the advantages mentioned above is possible due to the pouch chambers being arranged around a n-fold axis of rotation.

Particularly in the case of a film pouch having a circular or polygonal, for example quadrangular or triangular, outer contour of the film pouch in the sealing plane, a centrally arranged n-fold axis of rotation may be provided, around which the pouch chambers are arranged. This permits a very compact structure of the detergent product according to the invention. In addition, a product design which is very appealing from the user's point of view and which has the smallest possible sealing sections can thus be achieved. Consumer acceptance of the use of the detergent products according to the invention is therefore high.

Although not mandatory, nevertheless preferably at least two pouch chambers, preferably all pouch chambers, have an identical fill volume and/or an identical spatial shape. The term “identical” encompasses an exactly identical fill volume and/or an exactly identical spatial shape or also an approximately identical fill volume and/or an approximately identical spatial shape, which permits a deviation in the fill volume of less than 20%, preferably less than 10%, more preferably less than 5%, and/or an appearance of the pouch chambers which is not identical but is substantially the same from the user's point of view when viewed in three dimensions. With the pouch chambers being of the same design, a high intrinsic stability of the film pouch can be ensured and an intensive and even flow around all pouch chambers can be achieved, so that the latter dissolve at substantially the same rate. In addition, in three-dimensional space, fewer attachment surfaces are also created on which parts of laundry, such as buttons or appliqués, may become caught and then transport the film pouch along with them in an undesired manner. Finally, by forming pouch chambers of the same size, production of the detergent product according to the invention is simplified and the production costs are reduced. The fill volume of the pouch chambers may lie in the range between 1 ml and 50 ml, preferably in the range between 2 ml and 15 ml.

In order to solve the problem stated above, it is advantageous if the footprint of the pouch chamber located in the sealing plane is axially asymmetrical. The footprint is axially asymmetrical if it cannot be imaged onto itself by a perpendicular axis reflection at a mirror axis running through the footprint. By virtue of the axial asymmetry, it is possible to achieve flow conditions at the pouch chamber which lead to an improved and more even dissolution of the film material when the detergent product is used in a wash cycle. In addition, by virtue of a particular arrangement of the pouch chambers relative to one another, a compact structure of the film pouch can be achieved, wherein the width of the sealing sections between adjacent pouch chambers can be reduced. A modern product design with unusual pouch chamber shapes is possible, which draws the user's attention to the pouch chambers and the contents thereof. This helps to achieve a high level of consumer acceptance for the detergent product according to the invention. Against this background, one preferred embodiment of the invention provides droplet-shaped, leaf-shaped or yin-and-yang-shaped footprints of the pouch chambers. One particularly preferred contour of the pouch chamber in the sealing plane is characterized by a narrow convex end section and, opposite this in the longitudinal direction of the pouch chamber, a wide convex end section of the contour. The contour may be characterized by a first circular shape of smaller inner radius located at the narrow end section and by a second circular shape of larger inner radius located at the wider end section, wherein the ratio of the larger inner radius to the smaller inner radius may be for example more than 3:1, preferably more than 5:1, more preferably more than 8:1, or even more than 12:1. When producing the film pouch in a deep-drawing mold, the inner radii are predefined by the cavities of the deep-drawing mold. Between the narrow convex end section and the wide convex end section, the contour may be provided by a concave or straight inner section directed toward the middle of the film pouch and by a convex or straight outer section directed toward the outer edge of the film pouch, resulting in a droplet-shaped, leaf-shaped or yin-and-yang-shaped footprint of the pouch chamber.

One advantageous design of the pouch chamber contour in the sealing plane may provide that in each case a wide convex end section of the contour of a first pouch chamber is adjacent to or is located opposite a concave or straight inner section and/or a narrow convex end section of the contour of an adjacent second pouch chamber. As an alternative or in addition, the narrow convex end section of the contour of the second pouch chamber may also engage partially around the outside of the wide convex end section of the contour of the adjacent first pouch chamber. As an alternative or in addition, the wide convex end section of the contour of the first pouch chamber may intersect a tangent which is placed at the wide convex end section and at the narrow convex end section of the contour of the adjacent second pouch chamber. The wide convex end section of the first pouch chamber then extends into a concave region of the contour of the second pouch chamber. The contours described above permit a product design which is characterized by a very compact arrangement of the pouch chambers on the film pouch.

In particular, the transitions of the pouch chambers in the circumferential direction of the film pouch may be characterized by narrow sealing sections. Particularly in the radially outer regions between two adjacent pouch chambers, the sealing sections may have a maximum width of less than 5 mm, preferably of less than 3 mm, more preferably of only 2 mm or less. The detergent product can therefore less easily become caught on parts of laundry. This results in intensive contact of the film pouch with the washing liquor, the laundry drum and the laundry during a wash cycle, which results in an improved dissolution behavior of the film pouch. In addition, a higher intrinsic stability of the detergent product can thus be achieved. From the user's point of view, the product design can be made modern and interesting due to the unusual shape of the pouch chambers, wherein the user barely notices narrow sealing sections between the pouch chambers and the user's attention is drawn to the pouch chamber and the contents thereof.

In order to achieve the most homogenous possible flow over the pouch chambers and a good dissolution behavior as well as a high intrinsic shape stability with the narrowest possible sealing sections between the pouch chambers, the outer sections of the contours of the pouch chambers in the sealing plane may be located at least substantially on a common circumferential line, which may have a substantially circular, elliptical, super-elliptical, square, rectangular or triangular shape.

In connection with the invention, it has been found that particularly advantageous flow conditions at the pouch chambers and an overall very good dissolution behavior of the film pouch can be achieved if an area bisector of the footprint of a pouch chamber in the sealing plane turns to the left or to the right and if, preferably, a left-turning or right-turning arrangement of all pouch chambers is provided. The footprints of all pouch chambers may have outer contours and/or inner contours with the same direction of curvature at least in some sections. The area bisectors of all pouch chambers of the film pouch are then bent in the same direction, that is to say either to the left or to the right, which leads to an esthetically pleasing appearance of the detergent product according to the invention. In addition, curving the pouch chambers in the same direction may help the detergent product to come into intensive contact with the washing liquor and the items of laundry in the washing drum and “migrate through” the washing liquor without becoming caught on particular items of laundry and without riding onto the load of laundry or being conveyed to the porthole door.

For an improved dissolution behavior, particular advantage is achieved by a shape of the footprint of the pouch chamber, located in the sealing plane, in which the width of the footprint transverse to the area bisector first increases continuously along the area bisector from a narrow convex end section of the contour of the pouch chamber in the sealing plane toward an opposite wide convex end section of the contour, until a maximum value of the width is reached. The width may then decrease again toward the wide convex end section. Correspondingly, the cross-sectional area of the pouch chamber perpendicular to the sealing plane may increase continuously along the area bisector from the narrow convex end section of the contour until a maximum value is reached, and then may decrease again until the wide convex end section is reached. The pouch chamber may then have a helical structure both in two-dimensional space in the sealing plane and in three-dimensional space in the circumferential direction or direction of rotation of the area bisector. In this case, the cross-sectional area of the pouch chamber may first increase over a relatively long section of the area bisector until the maximum value is reached and then may decrease again over a shorter section after reaching the maximum value. The same may apply to the width of the footprint.

The subsequent pouch chamber may then follow with a similar cross-sectional profile, wherein the maximum cross-sectional area of a subsequent pouch chamber in the series may be identical to the maximum cross-sectional area of a preceding pouch chamber or may be larger or smaller than the maximum cross-sectional area of a preceding pouch chamber. If the contour of the pouch chamber in the sealing plane has a narrow convex end section and a wide convex end section located opposite the narrow convex end section, the maximum cross-section or the maximum width of the pouch chamber may lie in the region of the mid-point of a circular arc placed from the inside against the wide convex end section.

In order to achieve stronger turbulence in the middle region of the film pouch, at least one central chamber may be provided which is arranged in the middle region of the film pouch, wherein the pouch chambers are then arranged around the central chamber. The dissolution behavior of the detergent product is thus optimized, and a high intrinsic stability against undesired folding of the pouch chambers when holding the detergent product is achieved.

The central chamber is separated from each pouch chamber by a sealing section, wherein the central chamber may be at an equal distance from each pouch chamber. The minimum width of the sealing section between a pouch chamber and the central chamber may be less than 5 mm, preferably less than 3 mm, more preferably less than 2 mm. It is thus possible to achieve a high intrinsic shape stability and a compact product design that is appealing from the user's point of view.

The central chamber has a footprint in the sealing plane, wherein the footprint may be circularly symmetrical or n-fold rotationally symmetrical, where n is the number of pouch chambers of the film pouch. By way of example, the central chamber may have a circular footprint or a polygonal footprint, preferably a square, triangular, star-shaped, propeller-shaped or fan-wheel-shaped footprint. The central chamber may have in the sealing plane for example a triangular footprint with convexly curved corner sections and convex and/or concave and/or wavy side sections. In three-dimensional space, the central chamber may be semi-spherical for example. By designing the central chamber in a rotationally symmetrical manner in two-dimensional space, that is to say based on a plan view of the footprint of the central chamber in the sealing plane, and/or in three-dimensional space, that is to say based on a perspective view of the central chamber, account is taken of the basic inventive concept of arranging the pouch chambers around an n-fold axis of rotation and this basic concept is further developed in order to enhance the advantages described above. The central chamber is thus in particular designed differently and thus has a different spatial shape than the other pouch chambers surrounding it.

The method for producing the detergent product according to the invention and also the water-soluble films used for producing the product are generally known to a person skilled in the art. Examples of preferred polymers, copolymers or derivatives which are suitable for use as pouch chambers, as well as suitable detergent preparations, are described in DE 10 2014 102 567 A1. The content of the disclosure of the aforementioned document is hereby incorporated in the content of the disclosure of the description of the present invention.

### BRIEF DESCRIPTION OF THE DRAWINGS

The invention will be explained in greater detail below by way of example and with reference to the figures. The features mentioned and described above and also the features shown in the drawing and described below can be combined as required, even if this is not shown in detail. The invention is not limited to the features and combinations of features shown in the figures.

In the figures:

FIG. 1 shows a first embodiment of a detergent product according to the invention comprising a film pouch having three pouch chambers, in a perspective view at an angle from above;

FIG. 2 shows a plan view of the footprints of the pouch chambers and of the footprint of the film pouch in the sealing plane of the detergent product shown in FIG. 1;

FIG. 3 shows a view from below of the footprints of the pouch chambers and of the footprint of the film pouch in the sealing plane of the detergent product shown in FIG. 1;

FIG. 4 shows a side view of the detergent product shown in FIG. 1, in the viewing direction illustrated by I in FIG. 2;

FIG. 5 shows a side view of the detergent product shown in FIG. 1, in the viewing direction illustrated by II in FIG. 2;

FIG. 6 shows a side view of the detergent product shown in FIG. 1, in the viewing direction illustrated by III in FIG. 2;

FIG. 7 shows a side view of the detergent product shown in FIG. 1, in the viewing direction illustrated by IV in FIG. 2;

FIG. 8 shows another embodiment of a detergent product according to the invention comprising a film pouch having three pouch chambers and one central chamber in the middle, in a perspective view at an angle from above;

FIG. 9 shows a plan view of the footprints of the pouch chambers and of the footprint of the film pouch in the sealing plane of the detergent product shown in FIG. 8;

FIG. 10 shows a view from below of the footprints of the pouch chambers and of the footprint of the film pouch in the sealing plane of the detergent product shown in FIG. 8;

FIG. 11 shows a side view of the detergent product shown in FIG. 8, in the viewing direction illustrated by I in FIG. 9;

FIG. 12 shows a side view of the detergent product shown in FIG. 8, in the viewing direction illustrated by II in FIG. 9;

FIG. 13 shows a side view of the detergent product shown in FIG. 8, in the viewing direction illustrated by III in FIG. 9;

FIG. 14 shows a side view of the detergent product shown in FIG. 8, in the viewing direction illustrated by IV in FIG. 8;

FIG. 15 shows a third embodiment of a detergent product according to the invention comprising a film pouch having three pouch chambers and one dome-shaped central chamber with a triangular footprint in the sealing plane, in a perspective view at an angle from above;

FIG. 16 shows a plan view of the footprints of the pouch chambers and of the footprint of the film pouch in the sealing plane of the detergent product shown in FIG. 15;

FIG. 17 shows a view from below of the footprints of the pouch chambers and of the footprint of the film pouch in the sealing plane of the detergent product shown in FIG. 15;

FIG. 18 shows a side view of the detergent product shown in FIG. 15, in the viewing direction illustrated by I in FIG. 16;

FIG. 19 shows a side view of the detergent product shown in FIG. 15, in the viewing direction illustrated by II in FIG. 16;

FIG. 20 shows a side view of the detergent product shown in FIG. 15, in the viewing direction illustrated by III in FIG. 16;

FIG. 21 shows a side view of the detergent product shown in FIG. 15, in the viewing direction illustrated by IV in FIG. 16;

FIG. 22 shows a fourth embodiment of a detergent product according to the invention comprising a film pouch having three pouch chambers and one dome-shaped central chamber with a distorted triangular footprint in the sealing plane, in a perspective view at an angle from above;

FIG. 23 shows a plan view of the footprints of the pouch chambers and of the footprint of the film pouch in the sealing plane of the detergent product shown in FIG. 22;

FIG. 24 shows a view from below of the footprints of the pouch chambers and of the footprint of the film pouch in the sealing plane of the detergent product shown in FIG. 22;

FIG. 25 shows a side view of the detergent product shown in FIG. 22, in the viewing direction illustrated by I in FIG. 23;

FIG. 26 shows a side view of the detergent product shown in FIG. 22, in the viewing direction illustrated by II in FIG. 23;

FIG. 27 shows a side view of the detergent product shown in FIG. 22, in the viewing direction illustrated by III in FIG. 23;

FIG. 28 shows a side view of the detergent product shown in FIG. 22, in the viewing direction illustrated by IV in FIG. 23;

FIG. 29 shows an embodiment of a detergent product according to the invention comprising a film pouch having four pouch chambers, in a perspective view at an angle from above;

FIG. 30 shows a plan view of the footprints of the pouch chambers and of the footprint of the film pouch in the sealing plane of the detergent product shown in FIG. 29;

FIG. 31 shows a view from below of the footprints of the pouch chambers and of the footprint of the film pouch in the sealing plane of the detergent product shown in FIG. 29; and

FIG. 32 shows a side view of the detergent product shown in FIG. 29, in the viewing direction illustrated by I in FIG. 30.

### DETAILED DESCRIPTION OF THE INVENTION

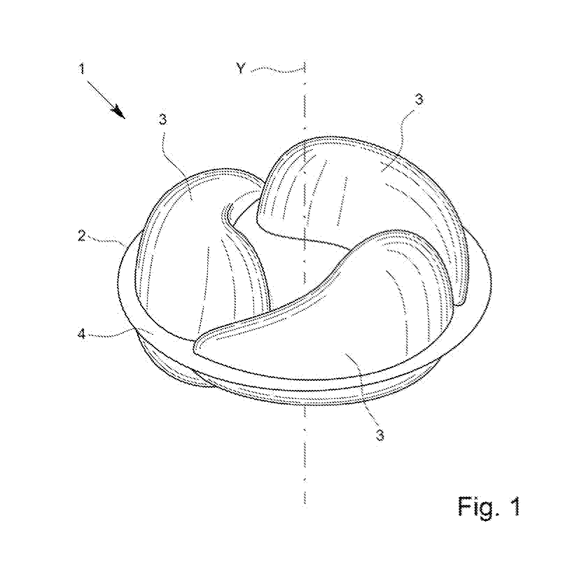

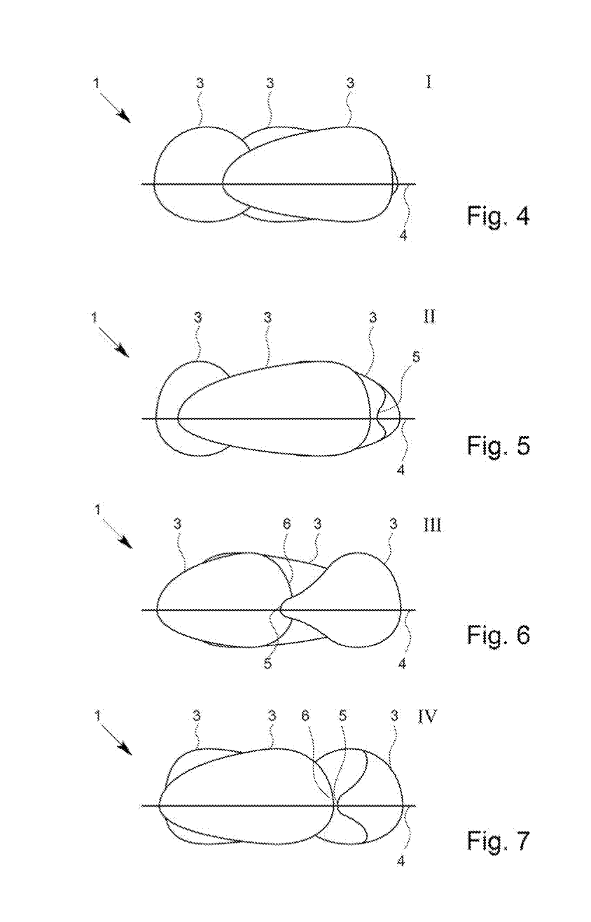

FIGS. 1 to 7; 8 to 14; 15 to 21; 22 to 28; 29 to 32 show different embodiments of detergent products 1 for treating textiles, in the form of single-use portion packs. Such a portion pack is used only once for treating textiles, usually in a textile washing machine. Each detergent product 1 comprises a film pouch 2 having three or four pouch chambers 3. Accommodated in the individual pouch chambers 3 are detergent preparations which may contain active washing substances for treating textiles, in particular for washing textiles. Water-soluble PVA films with the type designation M8630 or M8720 from the film manufacturer Monosol can be used to produce the film pouch 2. Alternatively, suitable water-soluble films from other film manufacturers, such as for example Aicello, Nippon Gohsei or Mondi, can also be used.

The film pouch 2 is formed of two water-soluble films, which may be in the form of PVA films. The water-soluble films enclose the pouch chambers 3 by forming the boundary walls thereof. The films are connected to one another in the region of sealing sections 4 in such a way that the pouch chambers 3 are each sealed and separated from one another around the entire circumference by the sealing sections 4. Thus, between two adjacent pouch chambers 3, in each case a sealed film section is also provided, which connects the pouch chambers 3 to one another in order to achieve a single portion pack.

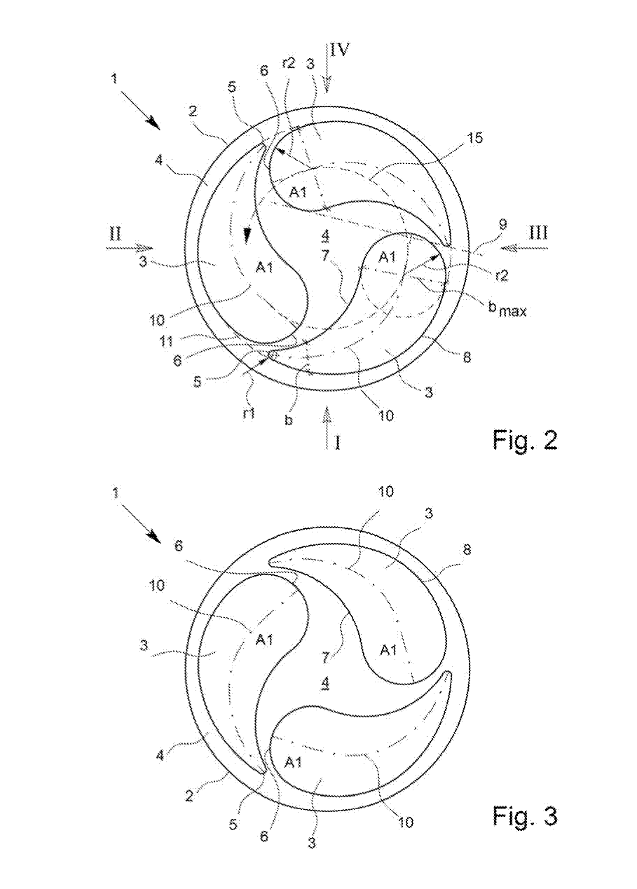

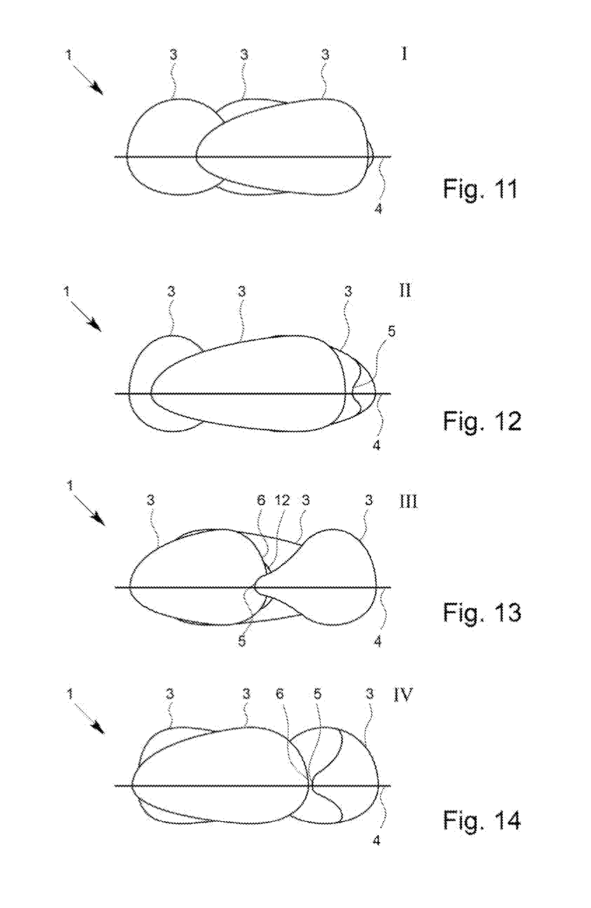

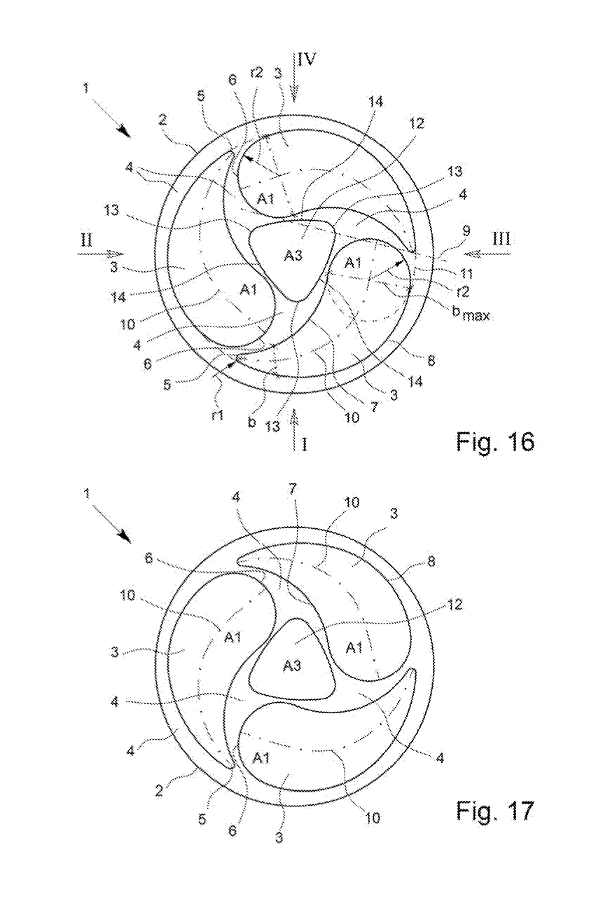

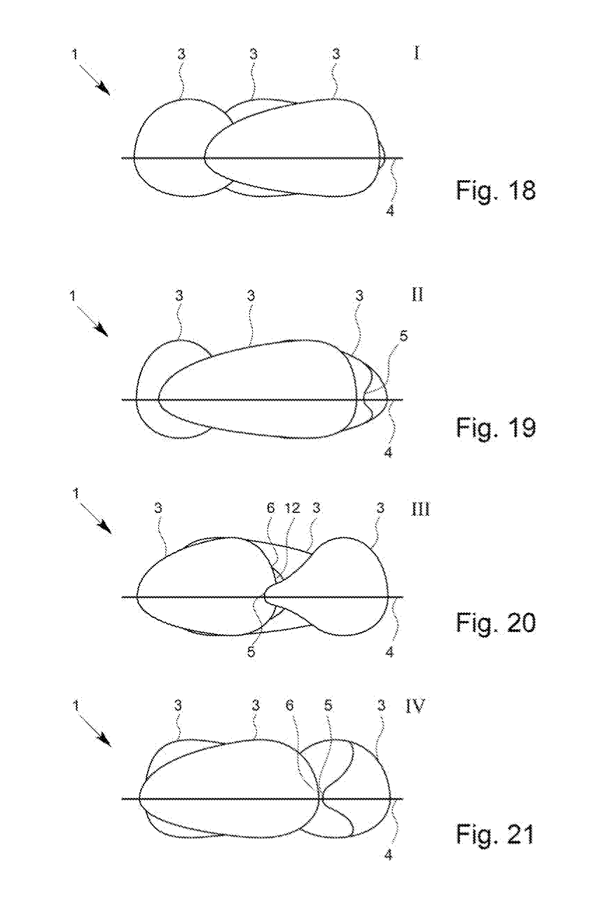

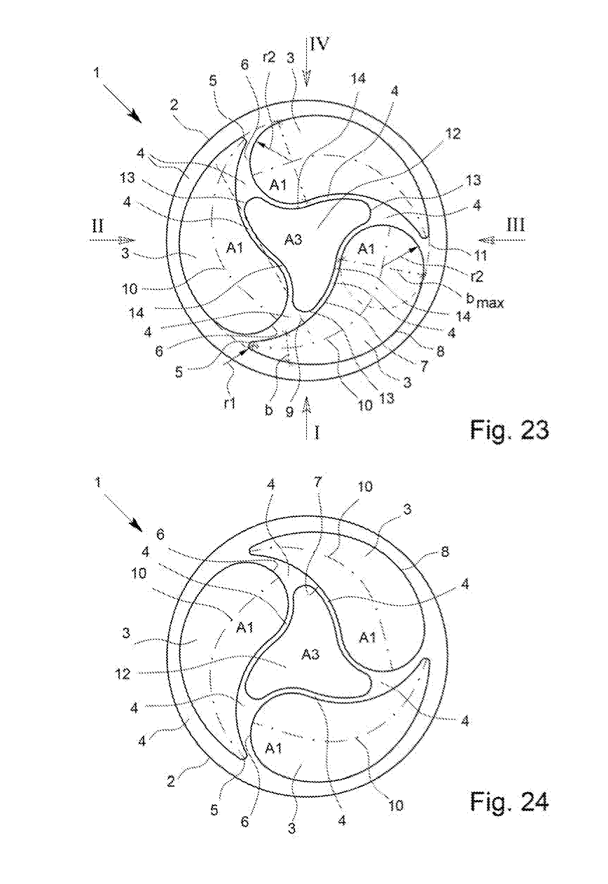

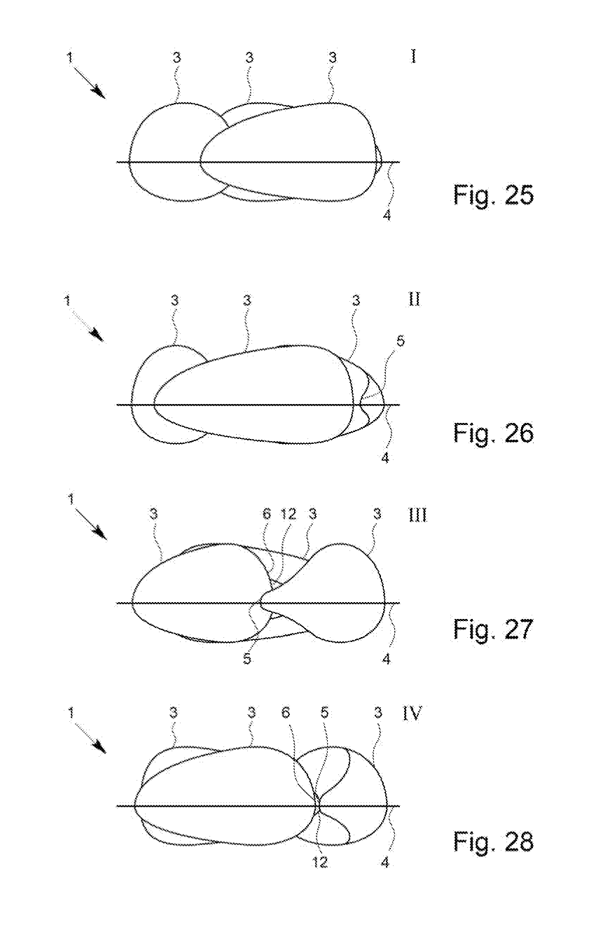

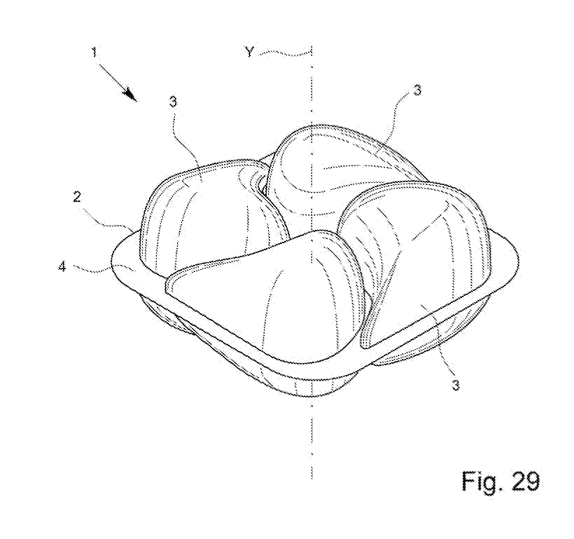

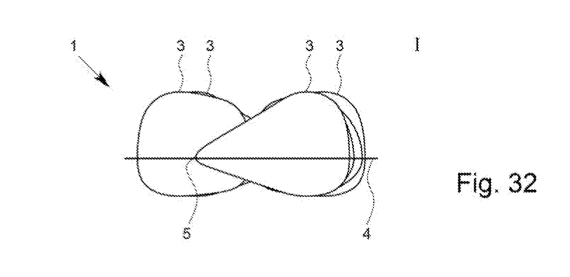

The pouch chambers 3 each have an identical footprint A1 in the sealing plane or connecting plane between the films (FIGS. 2, 3; 9, 10; 16, 17; 23, 24; 30, 31), while the total detergent product 1 or film pouch 2 has the footprint A2 in the sealing plane. The footprint A1 of a pouch chamber 3 is delimited by the contour line of the respective pouch chamber 2 in the sealing plane. The footprint A2 of the (total) detergent product 1 is delimited by the contour line thereof in the sealing plane. In the embodiments shown in FIGS. 1 to 28, a substantially circular or super-elliptical footprint A2 of the detergent product 1 is provided. The embodiment shown in FIGS. 29 to 32 has a substantially square footprint A2 of the detergent product 1, with rounded corner regions.

In all the embodiments shown, the footprints A1 of the pouch chambers 2 are each droplet-shaped or teardrop-shaped with a narrow convex end section 5 of the contour line of the respective pouch chamber 3 in the sealing plane (having a smaller inner radius r1) and with a wider convex end section 6 (having a larger inner radius r2) located opposite this in the longitudinal direction of the pouch chamber 3. Provided between the two convex sections 5, 6 at the ends of the pouch chamber 3 is a concave or possibly even straight connecting section 7 radially on the inside and a convex or straight connecting section 8 radially on the outside.

The different product designs of the detergent products 1 shown in FIGS. 1 to 32, that is to say in particular the geometric configuration (shape), the size and the arrangement of the pouch chambers 3 relative to one another, will be explained in detail below. All the embodiments shown have the common feature that a plurality of pouch chambers 3 are provided in a number n≥3, wherein the pouch chambers 3 are arranged in at least one sectional plane, in the present case the sealing plane, around a common n-fold axis of rotation Y that is perpendicular to the sectional plane (FIGS. 1, 8, 15, 22, 29). A compact arrangement of the pouch chambers 3 is provided as a result, with narrow sealing sections 4 between the pouch chambers 3, so that optimal use can be made of the product capacities of the apparatus and plant used to produce the detergent product 1. The pouch chambers 3 are arranged around a middle region of the film pouch 2 and one after the other in the circumferential direction (FIG. 2, arrow 15).

The compact arrangement of the pouch chambers 3 moreover reduces the attachment surfaces on which parts of laundry, such as buttons or appliqués, may become caught. If this happens, the detergent product 1 may stick to the laundry item in question and be transported with the latter, so that on the whole the circulating movements of the detergent product 1 during a wash cycle in a textile washing machine decrease and the film pouch 2 is exposed to a less intensive flow of washing liquid. The restricted movement of the detergent product 1 and the reduced flow around the latter impair the dissolution behavior of the water-soluble film pouch 2, namely the rate of dissolution and the degree of dissolution achieved during a wash cycle.

In addition, the compact arrangement of the pouch chambers 3 leads to a higher intrinsic stability of the film pouch 2, which increases user acceptance of the detergent products 1.

An improved dissolution behavior of the film pouch 3 also results from a flow-optimized design of the pouch chambers 3 and from a flow-optimized arrangement of the pouch chambers 3 relative to one another. In the embodiments shown, a turbulent flow around the pouch chambers 3 takes place during a wash cycle, so that in particular the sealing sections 4 of the film pouch which are located between adjacent pouch chambers 3 dissolve in a shorter period of time and to a more complete extent than is the case with the detergent products 1 known from the prior art. The transitions of the pouch chambers 3 in the (radially) outer edge regions of the film pouch 2 are characterized by narrow sealing sections between adjacent pouch chambers 3, so that the user's attention is drawn to the pouch chambers 3 and the contents thereof. This results in a very appealing, “innovative” product design, which contributes to a high level of user acceptance.

The detergent products 1 shown in FIGS. 1 to 28 each have three pouch chambers 3 with identical footprints A1 in the sealing plane, the footprints A1 being arranged around a common 3-fold axis of rotation Y that is perpendicular to the sealing plane. When the film pouch 2 or the detergent product 1 rotates about the axis of rotation Y, the arrangement of the pouch chambers 3 when rotated in each case through 120° remains substantially indistinguishable from the starting state, thereby resulting in a total of three symmetry-equivalent or substantially congruent arrangements of the footprints A1.

In the embodiment shown in FIGS. 1 to 7, the pouch chambers 3 are arranged around an uninterrupted sealing section 4 in the middle region of the film pouch 1. The pouch chambers 3 are arranged one after the other in the longitudinal direction of the pouch chambers 3 and in the circumferential direction of the footprint A2 of the film pouch 2 and do not overlap one another. All the pouch chambers 3 have an identical fill volume and an identical spatial shape.

In addition, the footprint A1 is axially asymmetrical. The footprint A1 may be droplet-shaped in each case. Based on a circular shape of smaller inner radius r1 located in the sealing plane at the narrow convex end section 5 of the contour of the pouch chamber 3 and a circular shape of larger inner radius r2 located at the wider convex end section 6, according to FIG. 2 the ratio of the larger inner radius r2 to the smaller inner radius r1 is around 5:1 or more.

As can also be seen from FIG. 2, adjacent pouch chambers 3 are arranged relative to one another in such a way that the wider convex end section 6 of the contour of a first pouch chamber 3 is located opposite the concave connecting section 7 of a subsequent second pouch chamber 3 in the circumferential direction. The narrower convex end section 5 of the subsequent second pouch chamber 3 is offset radially outward in relation to the wider convex end section 6 of the first pouch chamber 3 with respect to the area bisectors 10 of the two footprints A1 of the adjacent pouch chambers 3. Here, the starting point of the area bisector 10 of the footprint A1 at the narrow end of a subsequent pouch chamber 3 in the circumferential direction of the film pouch 2 is offset radially outward in relation to the end point of the area bisector 10 of the footprint A1 at the wide end of a preceding pouch chamber 3.

The wider convex end section 6 of the contour of a preceding pouch chamber 3 in the sealing plane additionally intersects a tangent 9 which is placed at the narrow convex end section 5 and at the wide convex end section 6 of the contour of a subsequent pouch chamber 3 and thus extends into a concave region of the subsequent pouch chamber 3.

The connecting sections 7, 8 of the contours of all pouch chambers 3 in the sealing plane have the same direction of curvature from the narrow convex end section 5 to the wide convex end section 6 of the respective pouch chamber 3. The same applies to the area bisector 10. As shown in FIG. 2, when viewed from above, this results in a left-turning arrangement of the footprints A1 of the pouch chambers 3 in the direction from the narrow convex end section 5 to the wide convex end section 6 (or in a corresponding right-turning arrangement when viewing the film pouch 2 from below as shown in FIG. 3). It will be understood that a right-turning arrangement of the footprints A1 of the pouch chambers 3 may also be provided in plan view.

It can also be seen from FIG. 2 that the width b of the footprint A1 of each pouch chamber 3 transverse to the area bisector 10 first increases continuously from the narrow convex end section 5 toward the wide convex end section 6, until a maximum width is reached. The width then decreases continuously again toward the wide convex end section 6. The same applies to the cross-sectional area perpendicular to the sealing plane. From a narrow end of the pouch chamber 3 (cross-sectional area=0) toward a wide end of the pouch chamber 3 (cross-sectional area=0), the cross-sectional area first increases in the longitudinal direction of the pouch chamber 3 with a relatively small gradient over a relatively large length, until a maximum cross-sectional area of the pouch chamber 3 is reached, and, after reaching the maximum cross-sectional area, decreases again with a larger gradient over a shorter length until it reaches zero at the wider end of the pouch chamber 3. This is then followed by the subsequent pouch chamber 3 having an identical or similar cross-sectional profile, wherein the maximum cross-sectional area of the subsequent pouch chamber 3 in the embodiments shown in FIGS. 1 to 31 is in each case identical to the maximum cross-sectional area of a preceding pouch chamber 3.

The geometry of the pouch chamber 3 or of the envelope thereof is thus characterized by a helical structure in the direction of curvature of the area bisector 10, both in two-dimensional space in the sealing plane (in a plan view of the footprints A1) and in three-dimensional space (in a perspective view of the pouch chambers 3).

The maximum width of a footprint A1 and/or the maximum cross-sectional area of a pouch chamber 3 may be reached in each case in the region of the mid-point of a circular arc placed from the inside against the wide convex end section 6 of the contour line of the pouch chamber 3 in the sealing plane.

It should also be noted that, in the detergent products 1 shown in FIGS. 1 to 32, the convex outer connecting sections 8 of the contour lines of the pouch chambers 3 of a film pouch 2 are arranged on a common circumferential line 11 which runs at least substantially in a circular or super-elliptical shape. Other shapes of the circumferential line 11 are not ruled out. For example, the circumferential line may run in a rectangular or square shape. This also contributes to a compact structure. The smallest distance between two pouch chambers 2 following one another in the direction of the circumferential line 11 in the sealing plane may be preferably less than 5 mm, more preferably less than 3 mm, particularly preferably less than 2 mm. Due to the deformations which occur when producing the film pouch 2 by deep-drawing and due to the restoring forces of the film layers, adjacent pouch chambers 3 may even bear partially against one another in the use state of the detergent product 1.

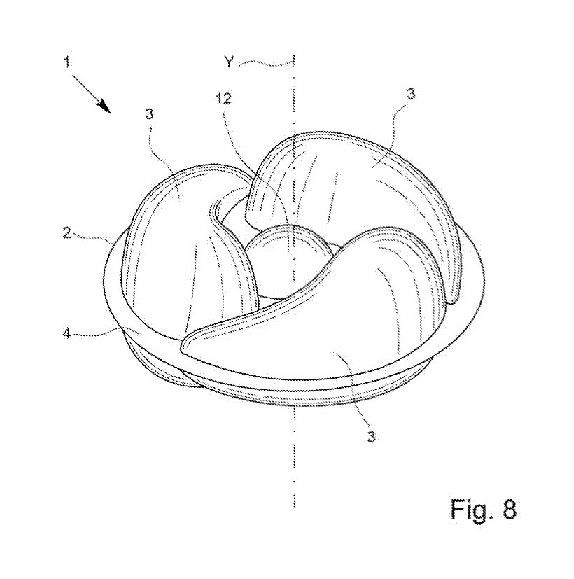

Only the differences between the detergent product 1 shown in the further FIGS. 8 to 32 and the embodiment already described and shown in FIGS. 1 to 7 will be explained in detail below. Coinciding features have been denoted by the same reference signs.

The detergent products 1 shown in the further FIGS. 8 to 28 each have a central chamber 12 in the middle region of the film pouch 2. The central chamber 12 is surrounded by the pouch chambers 3. When used in a textile washing machine, the central chamber 12 leads to considerable swirling of the washing water in the middle region of the film pouch 2 between the adjacent pouch chambers 3. The dissolution behavior of the film pouch 2 can thus be further optimized by virtue of the central chamber 12. To this end, the central chamber 12 thus fundamentally has, both with its footprint A3 and with its overall spatial shape, a different design to that of the surrounding pouch chambers 3.

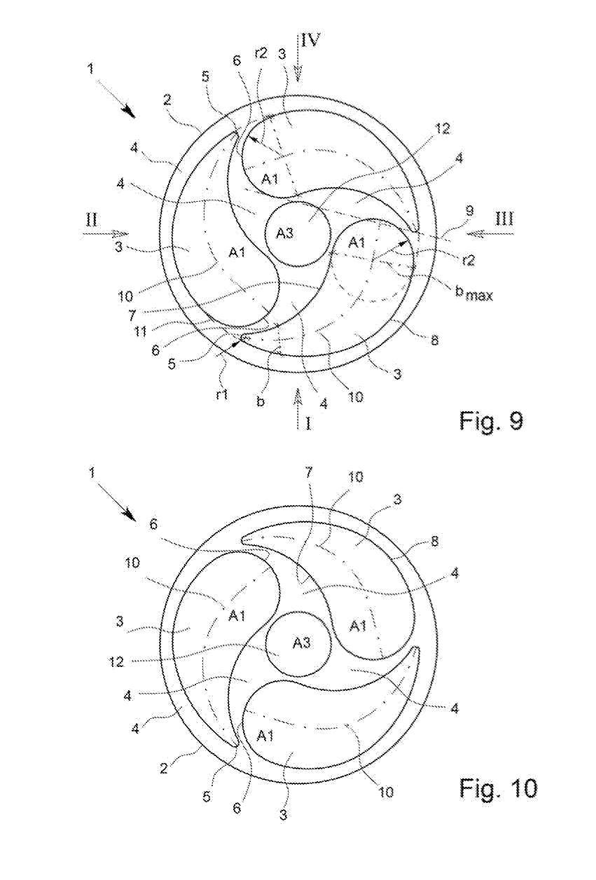

In the embodiment shown in FIGS. 8 to 14, a spherical central chamber 12 is provided, which has a circular footprint A3 in the sealing plane (FIG. 9).

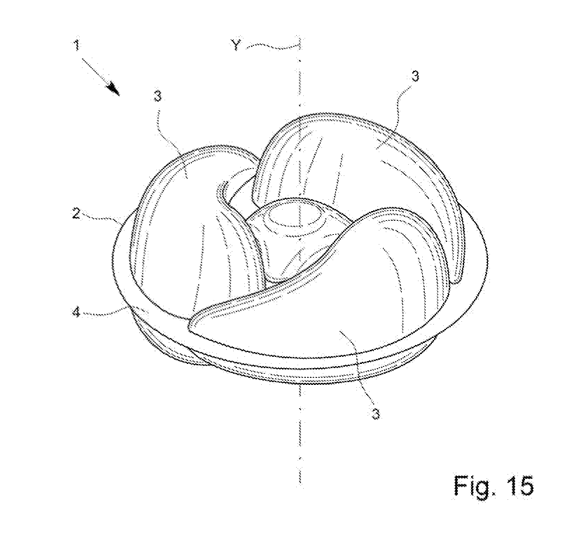

The embodiment shown in FIGS. 15 to 21 shows a central chamber 12 which has a triangular footprint A3 in the sealing plane and forms a respective dome on the upper side and on the underside of the film pouch 2. The footprint A3 is characterized by more strongly convexly curved corner sections 13 and only slightly convexly curved side sections 14. Compared to the embodiments shown in FIGS. 8 to 14 with a central chamber 12 which has a circular footprint A3 in the sealing plane, the surface area of the sealing sections 4 between the central chamber 12 and the adjacent pouch chambers 3 can be further reduced by a central chamber 12 having a triangular footprint A3. The sealing sections 4 between the central chamber 12 and the pouch chambers 3 are thus less noticeable to a user, which helps to achieve an esthetically pleasing appearance of the detergent product 1 and draws the user's attention even more to the pouch chambers 3 and the detergent preparations contained therein.

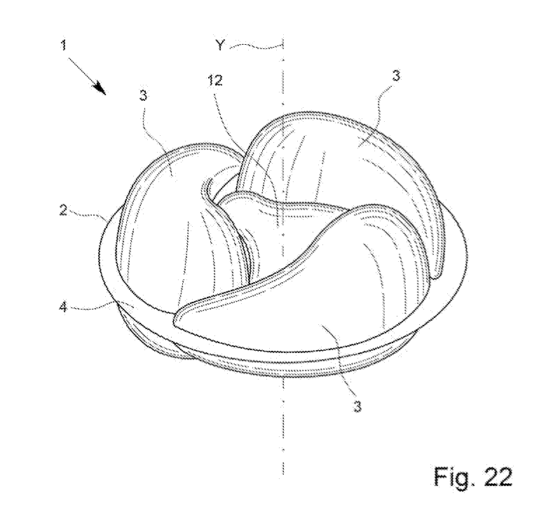

The embodiment shown in FIGS. 22 to 28 has a central chamber 12 with a footprint A3 having a contour that is even more strongly matched to the contour of the adjacent pouch chambers 3. This leads to a substantial minimizing of the size of the sealing areas in the middle region of the film pouch 2 between the pouch chambers 3. The footprint A3 of the central chamber 12 has approximately the shape of a distorted triangle, with convex corner sections 13 and S-shaped or wavy side sections 14 therebetween. The minimal distance between the footprint A3 of the central chamber 12 and the footprints A1 of the adjacent pouch chambers 3 remains substantially constant over the course of the side sections 14.

In the embodiments shown in FIGS. 15 to 28, the footprints A3 of the central chambers 12 are each designed and arranged in a three-fold rotationally symmetrical manner.

The detergent product 1 shown in FIGS. 29 to 32 has four pouch chambers 3 which are arranged around a four-fold axis of rotation that is perpendicular to the sealing plane. Both embodiments have pouch chambers 3 with droplet-shaped footprints A1 located in the sealing plane. The footprints A1 of the embodiment shown in FIGS. 29 to 32 are of identical design. The convex wider end section 6 of the contour line of a pouch chamber 3 of the embodiment shown in FIGS. 29 to 32 has a larger arc length in the sealing plane than the embodiments shown in FIGS. 1 to 28.

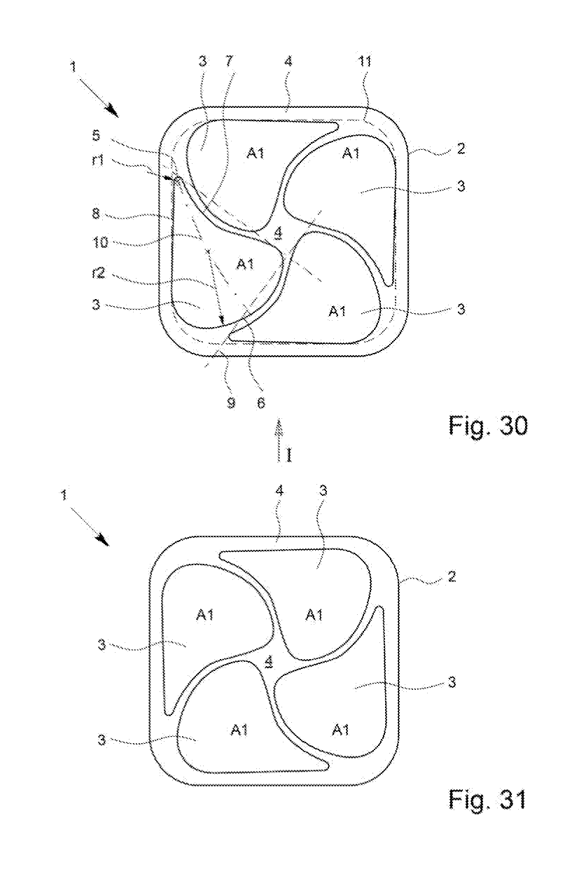

In addition, as shown in FIG. 30, it is provided that the outer connecting sections 8 of the contour of the pouch chambers 3 in the sealing plane are straight. The straight connecting sections 8 are located on a common circumferential line 11 that is substantially square. A very compact structure of the film pouch 2 is thus achieved, with a tight arrangement of the pouch chambers 3. Starting from a narrow convex end section 5 along the area bisector 10 toward a wide convex end section 6 of the contour line of a pouch chamber 3, the footprints A1 of all pouch chambers 3 are each arranged in a left-turning manner in a view from above (FIG. 30) or in a right-turning manner in a view from below (FIG. 31). In addition, also in this embodiment, all pouch chambers 3 are of identical shape and have an identical fill volume.

### LIST OF REFERENCE SIGNS

1 detergent product
2 film pouch
3 pouch chamber
4 sealing section
5 end section
6 end section
7 connecting section
8 connecting section
9 tangent
10 area bisector
11 circumferential line
12 central chamber
13 corner section
14 side section
15 arrow

What is claimed is:

1. A detergent product comprising a film pouch having a plurality of pouch chambers which are each enclosed by at least one water-soluble film, wherein the pouch chambers are formed by water-soluble films connected to one another in a sealing plane and are separated from one another by sealing sections located in the sealing plane, and wherein the pouch chambers are each filled with a detergent preparation, wherein a plurality of pouch chambers are provided in a number n≥3, wherein the pouch chambers are arranged in at least one sectional plane around a common n-fold axis of rotation that is perpendicular to the sectional plane.

2. The detergent product according to claim 1, wherein the pouch chambers have identical footprints in the sealing plane, and in that the footprints in the sealing plane are arranged around a common n-fold axis of rotation that is perpendicular to the sealing plane.

3. The detergent product according to claim 1, wherein the film pouch has between three and ten pouch chambers.

4. The detergent product according to claim 1, wherein the pouch chambers are arranged in at least one sectional plane around a 3-fold to 9-fold axis of rotation.

5. The detergent product according to claim 1, wherein the pouch chambers are arranged in at least one sectional plane around a centrally arranged n-fold axis of rotation.

6. The detergent product according to claim 1, wherein at least two pouch chambers have an identical fill volume and/or an identical spatial shape.

7. The detergent product according to claim 1, wherein the pouch chamber has a footprint in the sealing plane, and in that the footprint is axially asymmetrical.

8. The detergent product according to claim 7, wherein the footprint is droplet-shaped or yin-and-yang-shaped.

9. The detergent product according to claim 7, wherein an area bisector of the footprint turns to the left or to the right, and in that a left-turning or right-turning arrangement of all pouch chambers is provided.

10. The detergent product according to claim 7, wherein the width of the footprint transverse to an area bisector of the footprint and/or the cross-sectional area of the pouch chamber perpendicular to the sealing plane first increases over a section of the length of the area bisector and decreases after reaching a maximum value.

11. The detergent product according to claim 1, wherein at least one central chamber is provided which is arranged in the middle region of the film pouch, and in that the pouch chambers are arranged around the central chamber.

12. The detergent product according to claim 11, wherein the central chamber is separated from each pouch chamber by a sealing section, and in that the central chamber is at an equal distance from each pouch chamber.

13. The detergent product according to claim 11, wherein the minimum width of the sealing section between a pouch chamber and the central chamber is less than 5 mm.

14. The detergent product according to claim 11, wherein the central chamber has a footprint in the sealing plane, and in that the footprint is circularly symmetrical or n-fold rotationally symmetrical, where n is the number of pouch chambers.

15. The detergent product according to claim 14, wherein the central chamber has a circular footprint or a polygonal footprint.

16. The detergent product according to claim 1, for treating textiles comprising a film pouch having a plurality of pouch chambers which are each enclosed by at least one water-soluble film, wherein the pouch chambers are formed by water-soluble films connected to one another in a sealing plane and are separated from one another by sealing sections located in the sealing plane, and wherein the pouch chambers are each filled with a detergent preparation, wherein a plurality of pouch chambers are provided in a number n≥3, wherein the pouch chambers are arranged in at least one sectional plane around a common n-fold axis of rotation that is perpendicular to the sectional plane.

17. The detergent product according to claim 1, for cleaning textiles and/or washing textiles, comprising a film pouch having a plurality of pouch chambers which are each enclosed by at least one water-soluble film, wherein the pouch chambers are formed by water-soluble films connected to one another in a sealing plane and are separated from one another by sealing sections located in the sealing plane, and wherein the pouch chambers are each filled with a detergent preparation, wherein a plurality of pouch chambers are provided in a number n≥3, wherein the pouch chambers are arranged in at least one sectional plane around a common n-fold axis of rotation that is perpendicular to the sectional plane.

18. The detergent product according to claim 3, wherein the film pouch has between three and five pouch chambers.

19. The detergent product according to claim 4, wherein the pouch chambers are arranged in at least one sectional plane around a 3-fold, 4-fold, or 5-fold axis of rotation.

20. The detergent product according to claim 6, wherein all pouch chambers have an identical fill volume and/or an identical spatial shape.
